(19) United States
(12) Patent Application Publication
(10) Pub. No.: US 2013/0146524 A1
(43) Pub. Date: Jun. 13, 2013

(54) Fuel Filter of an Internal Combustion Engine and Filter Element of a Fuel Filter

(71) Applicant: MANN+HUMMEL GMBH, Ludwigsburg (DE)

(72) Inventors: Martin Veit, Gaertringen (DE); Martin Klein, Ludwigsburg (DE)

(73) Assignee: MANN+HUMMEL GMBH, Ludwigsburg (DE)

(21) Appl. No.: 13/709,360

(22) Filed: Dec. 10, 2012

(30) Foreign Application Priority Data
Dec. 9, 2011 (DE) 102011120648.9

(51) Int. Cl. F02M 37/22

(52) U.S. Cl. CPC F02M 37/221
USPC 210/300; 210/315

(57) ABSTRACT

A fuel filter of an internal combustion engine has a housing with a fuel inlet, a fuel outlet for cleaned fuel, and a water outlet for water separated from the fuel. A filter element is arranged in the housing and separates fuel inlet and fuel outlet seal-tightly. The filter element has a filter medium configured as a hollow member for filtering the fuel and further has a hydrophobic fuel-permeable separating medium embodied as a hollow member for separating water from the fuel. The separating medium is arranged in flow direction of the fuel downstream of the filter medium and is positioned inside the filter medium or surrounds the filter medium. Between the filter medium and the separating medium a precipitation slot is realized that has a conical shape and is connected with the water outlet. The separating medium extends at least across the entire extension of the filter medium.

### CROSS REFERENCE TO RELATED APPLICATIONS

This application claims the benefit of foreign application DE 102011120648.9 filed in Germany on Dec. 9, 2011, and which is hereby incorporated by reference in its entirety.

### BACKGROUND OF THE INVENTION

The invention concerns a fuel filter of an internal combustion engine, in particular of a motor vehicle, comprising a housing comprising at least one fuel inlet for the fuel to be cleaned, at least one fuel outlet for the cleaned fuel, and at least one water outlet for water separated from the fuel, and in which a filter element is arranged that separates the fuel inlet seal-tightly from the fuel outlet, that comprises a filter medium configured as a hollow member for filtering the fuel and, in flow direction of the fuel downstream of the filter medium, in its interior or surrounding it, comprises a hydrophobic fuel-permeable separating medium embodied as a hollow member for separating water contained in the fuel, that are arranged such that between the filter medium and the separating medium a precipitation slot is realized that widens conically and that is connected with the water outlet.

Moreover, the invention concerns a filter element of a fuel filter of an internal combustion engine, in particular of a motor vehicle, which can be arranged in a housing of the fuel filter so that it separates a fuel inlet of the housing seal-tightly from a fuel outlet, that comprises a filter medium configured as a hollow member for filtering the fuel and, in flow direction of the fuel downstream of the filter medium, in its interior or surrounding it, comprises a hydrophobic fuel-permeable separating medium embodied as a hollow member for separating water contained in the fuel, that are arranged such that between the filter medium and the separating medium a precipitation slot is realized that widens conically and that is connectable to a water outlet of the housing.

EP 1 233 173 A2 discloses a liquid filter for fuels as it is used for cleaning diesel fuel. The liquid filter has a filter housing with an inlet connector for diesel fuel to be cleaned and an outlet connector for cleaned diesel fuel. Moreover, the liquid filter has a central tube that is used for removing water that has been separated from the diesel fuel. In the interior of the housing a filter element is arranged in such a way that is disposed between the inlet connector and the outlet connector. The filter element has a star-shaped insert that is flowed through in radial direction from the exterior to the interior. In the upper area of the interior of the star-shaped insert, a separating insert is arranged that has a conical shape. This separating insert is comprised preferably of a water-repellent material in order to improve the water separation at the clean side of the star-shaped insert. The diesel fuel to be cleaned flows via the inlet connector to the dirt side in the filter housing. From here, it flows radially from the exterior to the interior through the star-shaped insert and reaches in cleaned form the clean side. Water particles that reach the clean side in this way sink in the interior of the star-shaped insert as a result of their greater density in downward direction and reach a water storage chamber where the separated water will collect. The cleaned diesel fuel flowing in the interior of the star-shaped insert in upward direction passes through the separating insert that by means of a water-repellent material assists water separation significantly. Downstream of the separating insert, the diesel fuel exits the filter housing via the outlet connector. Between the conical separating insert and the radial inner side of the star-shaped insert a precipitation slot is realized that widens conically in downward direction. This precipitation slot extends across less than half of the axial extension of the star-shaped insert.

The invention has the object to design a fuel filter and a filter element of a fuel filter of the aforementioned kind where filtering of particles from the fuel and the separation of water contained in the fuel are further improved.

### SUMMARY OF THE INVENTION

This object is solved in accordance with the invention in that the separating medium extends at least across the entire extension of the filter medium.

According to the invention, the separating medium completely covers the clean side of the filter medium so that the precipitation slot extends across the entire clean side of the filter medium. In this way, water separation can occur across the entire extension of the clean side of the filter medium. The separating efficiency of the filter element is improved in this way. When it is advantageously provided that the filter medium is flowed through in radial direction from the interior to the exterior, the separating medium is located outside of the filter medium and surrounds it. When in the alternative it is provided that the filter medium is flowed through from the exterior to the interior, the separating medium is arranged in an interior of the filter medium.

In the multi-stage filter element in particular particles that contaminate the fuel are filtered out in the filter medium. At the separating medium water droplets which are contained in the fuel are retained. The water droplets are precipitated in the precipitation slot and sink to the bottom as a result of their density. When a fuel is cleaned whose density is greater than that of the water, the water droplets will rise analogously. For this purpose, the filter element can be arranged in reverse. Also, the fuel inlet, the fuel outlet, and the water outlet can be arranged accordingly. Advantageously, the water can be collected in particular in a water collecting chamber that is connected to the water outlet. By widening the precipitation slot, it can be achieved that the local flow speed of the fuel is less than the precipitation speed of the water droplets.

A gradient of the flow speed of the fuel in the precipitation slot, depending on the flow direction from bottom to top or from top to bottom, can be counteracted so that the flow speed across the entire height of the filter medium remains almost constant. By means of the uniform flow speed in the precipitation slot it is prevented that water droplets are entrained by the fuel downstream of the separating medium in the flow direction. When the separating medium is conical and surrounds the filter medium, moreover a conically widened space between the separating medium and an inner wall of the housing can be realized. Accordingly, a constant flow speed can also be achieved at the drain side of the separating medium; this has a positive effect on the water separation. Because of the extension of the separating medium across the entire axial length of the filter medium and circumferentially, a correspondingly large surface area to be flowed through is achieved. In this way, the water separation is improved.

Moreover, the flow speed of the fuel is reduced which has a positive effect on the water separation. The separating medium that is at a slant relative to the filter medium improves moreover coalescing of the water droplets at the separating medium.

In an advantageous embodiment, the precipitation slot can point with its large cross-section in the flow direction of the water, in particular in downward direction, and can be connected there with the water outlet. The quantity of the water that is separated across the vertical height of the precipitation slot increases along its path that is predetermined due to the difference of the density relative to fuel, in particular in downward direction. In this way, the increase of the total quantity of separated water along the flow path can be compensated in a simple way so that a uniform flow speed of the water droplets can be realized.

Advantageously, between the filter medium and the separating medium a coalescing medium, in particular embodied as a hollow member, can be arranged that surrounds the filter medium or the separating medium. Advantageously, the coalescing medium delimits the precipitation slot at the side of the filter medium. At the coalescing medium, even smallest water droplets contained in the fuel can be separated and combined to larger water droplets. Large water droplets can precipitate downstream of the coalescing medium in the flow direction of the fuel in the precipitation slot, in particular sink to the bottom. In this way, the water separation can be improved.

Moreover, advantageously the filter medium, the separating medium, and optionally the coalescing medium can be arranged coaxially and the precipitation slot can widen conically in axial direction. A coaxial arrangement saves space. Moreover, in a coaxial arrangement the course of the flow of the fuel from the exterior to the interior in radial direction or from the interior to the exterior in radial direction can be optimized in a simple way.

Moreover, advantageously the filter medium and optionally the coalescing medium can be cylindrical and the separating medium can be conical. Advantageously, the coalescing medium can adjoin flat the clean side of the filter medium. Because of the cylindrical configuration the filter medium and the optional coalescing medium can be produced in a simple way. A conical separating medium can also be produced in a simple way.

Advantageously, the separating medium can be embodied like a screen. A screen-like, in particular, woven separating medium has the advantage that the water droplets are retained at the screen fibers and in particular will drip downwardly. On a screen-like separating medium the water is optimally retained. The mesh openings of a screen-like fabric can be predetermined in an easy and defined way. It can be designed to be optimally permeable for the fuel. The pressure loss can be minimized with a screen-like separating medium.

In other respects, the housing can be openable and the filter element can be exchangeably arranged in the housing. The filter element can thus be removed for exchange or for maintenance purposes from the housing.

The object is solved according to the invention moreover by the filter element in that the separating medium extends across the entire extension of the filter medium. The advantages and features that have been listed above in connection with the inventive fuel filter apply in the same way to the filter element according to the invention.

### BRIEF DESCRIPTION OF THE DRAWINGS

Further advantages, features and details of the invention result from the following description in which one embodiment of the invention will be explained in more detail with the aid of the drawing. A person of skill in the art will consider the features disclosed in combination in the drawing, the description and claims expediently also individually and combine them to other meaningful combinations.

FIG. 1 shows a longitudinal section of a fuel filter with an exchangeable three-stage filter element.

FIG. 2 shows an isometric illustration of the filter element of FIG. 1.

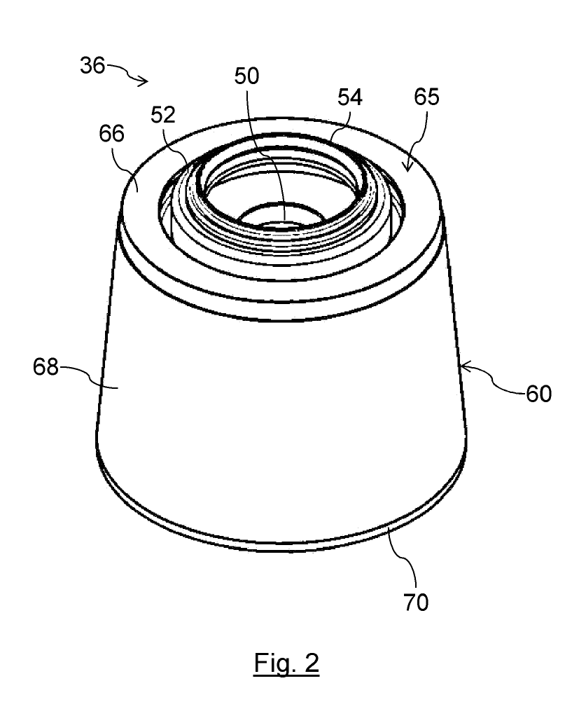

In the Figures same components are provided with same reference characters.

DESCRIPTION OF PREFERRED EMBODIMENTS

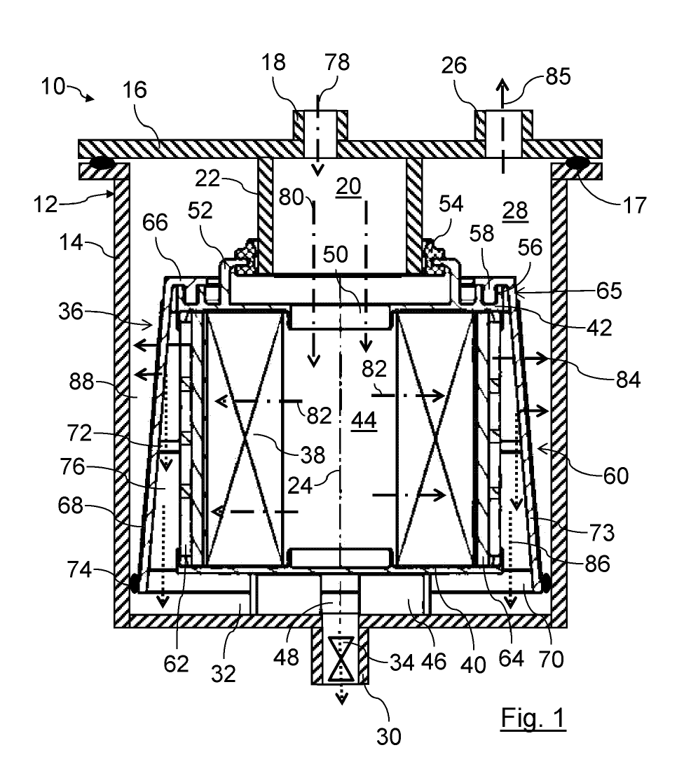

In FIG. 1, a fuel filter 10 of a fuel system of an internal combustion engine of a motor vehicle is illustrated in longitudinal section. The fuel filter 10 serves for cleaning the fuel that is used for operating the internal combustion engine, for example, diesel fuel. Moreover, the fuel filter 10 serves for separating water contained in the fuel.

The fuel filter 10 comprises a two-part housing 12 with a cup-shaped filter pot 14 and a filter cover 16 that is arranged on the filter pot 14 so as to be separable therefrom. Between the filter pot 14 and the filter cover 16 an annular seal 17 is arranged.

In the cover 16 approximately centrally an inlet socket 18 for the fuel to be cleaned is arranged which is connected outside of the housing 12 to a fuel supply line shown in FIG. 1. In the interior of the housing 12 the inlet socket 18 opens into an inlet chamber 20 in an interior of a connecting socket 22. The connecting socket 22 extends on the side of the cover 16 that is facing the interior of the housing 12 coaxially to a filter axis 24. The terms “axial”, “radial”, “coaxial” and “circumferential” relate to the filter axis 24, if nothing else is indicated.

In radial direction outside of the connecting socket 22 the cover 16 has moreover an outlet socket 26 which is connected to the drainage chamber 28 in the housing 12. External to the housing 12, this outlet socket 26 is connected to a fuel outlet line, not illustrated in FIG. 1, for the cleaned fuel.

At the bottom of the filter pot 14 a water discharge socket 30 is arranged coaxial to the filter axis 24. The water discharge socket 30 is connected to a water collecting chamber 32 at the bottom of the housing. External to the housing 12 the water discharge socket 30 is connected to a water discharge line, not illustrated, by means of which the water separated from the fuel is discharged from the housing 12. In the water discharge socket 30 a water discharge valve 34 with a water level sensor is arranged. At rest, the water discharge valve 34 is closed so that no liquid can escape from the water collecting chamber 32 through the water discharge socket 30 from the housing 12. Upon reaching a predetermined maximum water level in the water collecting chamber 32, the water discharge valve 34 opens automatically so that the separated water can be discharge through the water discharge socket 30.

In the housing 12 a filter element 36 is arranged. The filter element 36 separates the inlet socket 18 seal-tightly from the outlet socket 26. The filter element 36 comprises a star-shape folded filter medium 38 with which in particular particles are filtered from the fuel to be cleaned. The filter medium 38 has the shape of a coaxial circular cylinder. At an end face that is facing the bottom of the filter pot 14 the filter medium 38 is connected seal-tightly with a closure end disk 40. At the opposite end face that is facing the cover 16 the filter medium 38 is connected seal-tightly to the end disk 42.

The end disk 40 is of a continuous closed configuration. On its side that is facing the interior 44 of the filter medium 38 the closure end disk 40 has a support collar for the filter medium 38. On the exterior side that is facing the bottom of the filter pot 14, the closure end disk 40 has four support webs 46 which extend in uniform distribution about a coaxial imaginary circular cylinder wall. The imaginary circular cylinder wall surrounds the water outlet socket 30. With the support webs 46 the filter element 36 is supported on the bottom of the filter pot 14. Between the support webs 46 there are outlet openings 48 by means of which the water can flow from water collecting chamber 32 into the water outlet socket 30.

The connector end disk 42 has a coaxial inlet opening 50 which connects the inlet chamber 20 with the interior 44. The inlet opening 50 is surrounded by a central collar of the connector end disk 42 which extends coaxially into the interior 44 and on which is resting the radial inner side of the filter medium 38.

On the exterior side which is facing the cover 16 the connector end disk 42 has a coaxial connecting socket 52 that is coaxial to the filter axis 24. The connecting socket 52 is bent at its free end face by 90 degrees in radial direction inwardly. On the radial inner rim of the connecting socket 52 a profiled ring seal 54 is seated. Into the connecting socket 52 the connecting socket 22 of the cover 16 is inserted in such a way that the connection is sealed by the profiled ring seal 54.

In radial direction outwardly, on the connector end disk 42 two circumferential projections are arranged that are coaxial to the filter axis 24 and form a receiving groove 56 for an annular insertion web 58 of a separating unit 60 of the filter element 36.

In radial direction outwardly, the filter medium 38 is surrounded by a fluid-permeable coaxial support tube 62 that connects the connector end disk 42 stably with the closure end disk 40.

Between the radial outer circumferential side of the filter medium 38 and the support tube 62 there is a coaxial coalescing medium 64. The coalescing medium 64 is closed circumferentially and extends between the connector end disk 42 and the closure end disk 40. The coalescing medium 64, for example, a nonwoven, serves for combining even smallest water droplets in the fuel to larger water droplets.

The separating unit 60 comprises a support cage 65 with a connecting section 66, which also comprises the insertion web 58, and a separating medium 68. The connecting section 66 is approximately cup-shaped with a central opening at its bottom through which the connecting socket 52 passes. Its inner diameter is somewhat greater than the outer diameter of the connector end disk 42. The separating unit 60 is inserted with the separating medium 68 leading onto the connector end disk 42. At the side facing the closure end disk 40, the separating unit 60 is open toward the water collecting chamber 32.

The separating medium 68 is comprised of a hydrophobic screen fabric. It extends along a coaxial conical wall surface from the connector end disk 42 to the closure end disk 40. The base surface of the corresponding cone is arranged at the end of the closure end disk 40. The separating medium 68 projects past the closure end disk 40 in axial direction. It is circumferentially closed. It extends as a whole across the entire extension of the filter medium 38 and of the coalescing medium 64 at the clean side of the filter medium 38. It covers the filter medium 38 and the coalescing medium 64 completely when viewed in radial direction.

The support cage 65 at the open side that is facing away from the connecting section 66 has a coaxial lower support ring 70. Axially arranged between the lower support ting 70 and the connecting section 66 there is a coaxial central support ring 72. The connecting section 66, the central support ring 72 and the lower support ring 70 are connected to each by four axial webs 73 arranged in a circumferentially distributed arrangement. The separating medium 68 is resting against the radial outer sides of the connecting section 66, of the central support ring 72, of the lower support ring 70 and the axial webs 73.

At the radial outer circumferential side of the lower support ting 70, a ring seal 74 is also arranged which is supported in radial direction outwardly at the inner circumferential side of the filter pot 14. The annular seal 74 seals the drainage chamber 28 relative to the water collecting chamber 32.

Between the separating medium 68 and the filter medium 38 there is a precipitation slot 76. The precipitation slot 76 is an annular chamber that has a conical shape, i.e., widens conically in axial direction relative to the water collecting chamber 32. The precipitation slot 76 is delimited in radial direction inwardly by the hollow cylindrical coalescing medium 64 and in radial direction outwardly by the conical separating medium 68. In the illustrated vertical orientation of the filter axis 24 the precipitation slot 76 therefore widens conically in downward direction, i.e, the end with the large cross-section is positioned at the bottom and the end with the small cross-section at the top.

In operation of the fuel filter 10, the fuel to be cleaned is supplied from the fuel supply line, indicated by arrow 78, through the inlet socket 18 to the inlet chamber 20. From here, the fuel passes in the direction of arrows 80 through the inlet opening 50 into the interior 44 of the filter medium 38.

The fuel passes through the filter medium 38, indicated by arrows 82, from its raw side, in radial direction inward, to its clean side, in radial direction outward. Particles are removed thereby from the fuel. The filter medium 38 forms a first stage of the, in total, three-stage fuel filter 10 for cleaning/water separation. At the clean side the fuel from which the particles have been removed passes through the coalescing medium 64 in radial direction from the interior to the exterior. In doing so, even smallest water droplets that are contained in the fuel are caught and combined to larger water droplets. The coalescing medium 64 forms a second stage for cleaning/water separation.

The fuel and the large water droplets flow through the openings of the support tube 62 and pass into the precipitation slot 76.

The fuel flows through the separating medium 68, which forms a third stage for cleaning/water separation, in radial direction from the interior to the exterior, indicated by arrows 84, and passes into the drainage chamber 28. The conical widening of the precipitation slot 76 counteracts the tendency of the cleaned fuel to flow already in the upper area, in the area of the connector end disk 42, out of the precipitation slot 76 into the discharge chamber 28. In this way, a uniform fuel flow is achieved even through the filter medium 38. The uniform fuel flow in the filter medium 38 effects a uniform loading with particles which increases the service life of the filter element 38. Because of the separating medium 68, the flow speed of the fuel is also reduced. Because of the conical widening of the separating medium 68 and of the precipitation slot 76, it is achieved that the flow speed of the fuel, viewed in axial direction, is almost constant.

Between the separating medium 68 and the inner side of the circumferential wall of the filter pot 14 there is moreover an outer slot 88 which widens conically, opposite to the precipitation slot 76, in upward direction, i.e., away from the water collecting chamber 32. Because of this widening of the outer slot 88 the flow cross-section increases in upward direction so that the fuel flow is also calmed within the outer slot 88.

The cleaned fuel from which water has been also removed exits the discharge chamber 28 via the discharge socket 26, indicated by an arrow 85, and is supplied to the fuel discharge line.

The water droplets are retained by the separating medium 68. Along the separating medium 68 that extends at a slant to the filter axis 24 the water droplets are moved in spiral swirls to the surface and then away from it. In this way, the water droplets collide and combine to even larger water droplets. As soon as sufficiently large droplets sizes have been reached for precipitation, the water droplets sink in downward direction. indicated by arrows 86, as a result of their greater density in comparison to fuel into the water collecting chamber 32. Since the precipitation slot 76 widens in downward direction, i.e., in flow direction of the separated water, a compensation of the accumulation of the separated water in downward direction across the axial height of the coalescing medium 46 is provided. The flow cross-section for the water increases so that the flow speed remains constant. This leads to a calming action of the water flow and thus also to improved separation of water. By calming of the water flow and of the fuel flow in the precipitation slot 76 it is prevented that water droplets are entrained by the fuel away from the precipitation slot 76 and pass through the separating medium 68.

As soon as the water level sensor of the water drainage valve 34 has detected that the predetermined maximum water level has been reached, the water drainage valve 34 is automatically opened. The water exits the water collecting chamber 32 through the water outlet socket 30 and flows into the water discharge line.

For maintenance purposes, for example, for exchanging or cleaning the filter element 36, the cover 16 is removed in axial direction from the filter pot 14. The filter element 36 is then axially pulled out of the filter pot 14.

For installation, the filter element 36 with the closure end disk 40 leading is inserted in axial direction into the filter pot 14. Subsequently, the cover 16 with the connecting socket 22 leading is inserted in axial direction into the open side of the filter pot so that the connecting socket 22 projects seal-tightly into the profiled ring seal 54.

In the above described embodiment of a fuel filter 10 and of a filter element, the following modifications are possible 36 inter alia.

The invention is not limited to a fuel filter 10 of an internal combustion engine of a motor vehicle. Instead, it can be used also for different kinds of internal combustion engines, for example, industrial motors.

Instead of being used with diesel fuel, the fuel filter 10 can also be used for cleaning/water separation in connection with a different liquid fuel. When a fuel is used whose density is greater than that of water, the water droplets will rise analogously. In this case, the filter element 36 can be arranged in reverse. Also, the fuel inlet, the fuel outlet, and the water outlet can be arranged accordingly.

The filter medium 38, instead of being folded in a star shape, can also be designed as a different hollow member, for example, a hollow cylinder or hollow cone, for example, with round, oval or angular base surface.

Instead of the nonwoven, also a different coalescing medium 64, for example, a screen, a fabric or a granular material can be provided.

The annular seal 74 can also be eliminated. Preferably, the lower support ring 70 can rest seal-tightly against the radial inner circumferential side of the filter pot 14.

The separating medium 68, instead of surrounding the filter medium 38 and the coalescing medium 64 in radial direction outwardly, can also be arranged in the interior 44 of the filter medium 38. The fuel to be cleaned flows then through the filter medium 38 from the exterior to the interior in radial direction. The coalescing medium 64 should then also be arranged within the interior 44 of the filter medium 38.

Instead of the separating medium 68 it is also possible that the filter medium 38 and the coalescing medium 64 have a conical shape. The separating medium 68 can be, for example, of a hollow cylindrical shape. In addition or as an alternative, the radial inner circumferential wall of the filter pot 14 can also be conically shaped. In this way, the shape of the exterior slot 88 can be influenced.

The fuel to be cleaned can be supplied, instead of from the top, also from the bottom to the raw side of the filter medium 38. Then the water drainage socket 30, instead of being centrally arranged, can also be eccentrically positioned at the bottom of the filter pot 14.

Instead of the exchangeable filter element 36, it is also possible to provide a filter element that is fixedly mounted within the fuel filter.

The filter medium 38, the coalescing medium 64, or the separating medium 68 can have, instead of a round base surface, also a different one, for example, an oval or angular base surface.

The filter medium 38, the coalescing medium 64 and/or the separating medium 73 can also be arranged in a different way than coaxially relative to each other or to the filter axis 24.

While specific embodiments of the invention have been shown and described in detail to illustrate the inventive principles, it will be understood that the invention may be embodied otherwise without departing from such principles.

What is claimed is:

1. A fuel filter of an internal combustion engine, the fuel filter comprising:
a housing comprising at least one fuel inlet for fuel to be cleaned, at least one fuel outlet for cleaned fuel, and at least one water outlet for water separated from the fuel;
a filter element arranged in the housing and separating the fuel inlet seal-tightly from the fuel outlet;
the filter element comprising a filter medium configured as a hollow member for filtering the fuel;
the filter element further comprising a hydrophobic fuel-permeable separating medium embodied as a hollow member for separating water contained in the fuel from the fuel, wherein the separating medium is arranged in a flow direction of the fuel downstream of the filter medium and is positioned in an interior of the filter medium or surrounds the filter medium;
wherein the filter medium and the separating medium are arranged such that a precipitation slot is realized between the filter medium and the separating medium;
wherein the precipitation slot has a conical shape and is connected with the water outlet;
wherein the separating medium extends at least across the entire extension of the filter medium.

2. The fuel filter according to claim 1, wherein the conical shape of the precipitation slot has an end with a large cross-section and an end with a small cross-section, wherein the end with the large cross-section is positioned downstream in a flow direction of the separated water and the end with the large cross-section is connected with the water outlet.

3. The fuel filter according to claim 2, wherein the end with the large cross-section is positioned at a bottom end of the filter element.

4. The fuel filter according to claim 1, further comprising a coalescing medium that is arranged between the filter medium and the separating medium and is embodied as a hollow member.

5. The fuel filter according to claim 4, wherein the coalescing medium surrounds the filter medium or the separating medium.

6. The fuel filter according to claim 4, wherein the filter medium, the separating medium, and the coalescing medium are coaxially arranged and the precipitation slot widens conically in an axial direction of the filter element.

7. The fuel filter according to claim 4, wherein the filter medium and the coalescing medium are cylindrical and the separating medium is conical.

8. The fuel filter according to claim 1, wherein the filter medium and the coalescing medium are coaxially arranged and the precipitation slot widens conically in an axial direction of the filter element.

9. The fuel filter according to claim 4, wherein the filter medium is cylindrical and the separating medium is conical.

10. The fuel filter according to claim 1, wherein the separating medium is a screen.

11. The fuel filter according to claim 1, wherein the housing is openable and the filter element is exchangeably arranged in the housing.

12. A filter element of a fuel filter of an internal combustion engine, the filter element comprising:
a filter medium embodied as a hollow member for filtering fuel;
a hydrophobic fuel-permeable separating medium embodied as a hollow member for separating water contained in the fuel from the fuel;
wherein the separating medium is arranged in a flow direction of the fuel downstream of the filter medium in an interior of the filter medium or is arranged surrounding the filter medium;
wherein the filter medium and the separating medium are arranged such that a precipitation slot is realized between the filter medium and the separating medium, wherein the precipitation slot has a conical shape;
wherein the separating medium extends at least across the entire extension of the filter medium.
